(19) United States
(12) Patent Application Publication
(10) Pub. No.: US 2024/0296173 A1
(43) Pub. Date: Sep. 5, 2024

(54) INFORMATION PROCESSING DEVICE, CONTROL METHOD, AND STORAGE MEDIUM

(71) Applicant: NEC CORPORATION, Minato-ku, Tokyo (JP)

(72) Inventors: Genki Kusano, Tokyo (JP); Masafumi Oyamada, Tokyo (JP); Yuyang Dong, Tokyo (JP); Takuma Nozawa, Tokyo (JP)

(73) Assignee: NEC CORPORATION, Minato-ku, Tokyo (JP)

(21) Appl. No.: 18/272,630

(22) PCT Filed: Jan. 25, 2021
(86) PCT No.: PCT/JP2021/002433

§ 371 Date: Jul. 17, 2023

(51) Int. Cl. G06F 16/28

(52) U.S. Cl. CPC G06F 16/285

(57) ABSTRACT

The information processing device lx mainly includes a combination target data acquisition means 16X, a combination target element determination means 17X, and a data combination means 18X. The combination target data acquisition means 16X is configured to acquire combination target data that is data of a second data set to be combined with data of a first data set. The combination target element determination means 17X is configured to determine a combination target element to be combined with the data of the first data set, based on a function value of each element of the combination target data. The data combination means 18X is configured to combine the combination target element with the data of the first data set. X combines the element to be combined with the data of the first data set.

### TECHNICAL FIELD

The present disclosure relates to a technical field of an information processing device, a control method, and a storage medium for processing data.

### BACKGROUND ART

An example of a method of combining related data is disclosed in Patent Literature 1. Patent Literature 1 discloses an information processing system that includes a plurality of data processing devices and a data combination device, wherein the data processing devices process databases related to customers owned by companies and provide the processed databases to a data combination device and the data combination device combines the processed databases provided from each of the data processing devices to generate a combined database.

### CITATION LIST

### Patent Literature

Patent Literature 1: JP 2016-126609A

### SUMMARY

### Problem to be Solved

If data is combined with related data as they are, elements that should not be added are also added to the combined data, and the data after the combination becomes noisy data. Patent Literature 1 does not disclose such an issue and a solution method thereof.

In view of the above-described issue, it is therefore an example object of the present disclosure to provide an information processing device, a control method, and a storage medium capable of suitably combining data.

### Means for Solving the Problem

In one mode of the information processing device, there is provided an information processing device including:
a combination target data acquisition means configured to acquire combination target data that is data of a second data set to be combined with data of a first data set;
a combination target element determination means configured to determine a combination target element to be combined with the data of the first data set, based on a function value of each element of the combination target data; and
a data combination means configured to combine the combination target element with the data of the first data set.

In one mode of the control device, there is provided a control method executed by a computer, the control method including:
acquiring combination target data that is data of a second data set to be combined with data of a first data set;
determining a combination target element to be combined with the data of the first data set, based on a function value of each element of the combination target data; and
combining the combination target element with the data of the first data set.

In one mode of the storage medium, there is provided a storage medium storing a program executed by a computer, the program causing the computer to:
acquire combination target data that is data of a second data set to be combined with data of a first data set;
determine a combination target element to be combined with the data of the first data set, based on a function value of each element of the combination target data; and
combine the combination target element with the data of the first data set.

### EFFECT

An example advantage according to the present invention is to suitably combine data of a second data set with data of a first data set.

### BRIEF DESCRIPTION OF THE DRAWINGS

FIG. 1 It illustrates a schematic configuration of a data combination system in the first example embodiment.

FIG. 2 It illustrates an example of the hardware configuration of an information processing device.

FIG. 3 It is an example of a functional block diagram of the information processing device according to the first example embodiment.

FIG. 4 It is a diagram showing an outline of a mapping Sync.

FIG. 5 It is a diagram showing an outline of a method for specifying combination target data based on a probabilistic method.

FIG. 6 FIG. A illustrates an example of the data structure of the first data set representing a purchasing history in a supermarket.

FIG. 6B illustrates an example of the data structure of the second data set representing the browsing history in the internet.

FIG. 6C illustrates an example of a table information representing tags associated with each site.

FIG. 7 FIG. 7A illustrates a purchasing history data to be combined with other data.

FIG. 7B illustrates a browsing history data to be combination target data.

FIG. 8 It is a diagram showing an outline of generating expanded data.

FIG. 9 It is an example of a flowchart showing the procedure of the data combination process.

FIG. 10 It is an example of a functional block diagram of an information processing device in a modification.

FIG. 11 It is a block diagram of an information processing device according to a second example embodiment.

FIG. 12 It is an example of a flowchart in the second example embodiment.

### EXAMPLE EMBODIMENTS

Hereinafter, example embodiments of an information processing device, a control method, and a storage medium will be described with reference to the drawings.

### First Example Embodiment

### (1) Overall Configuration

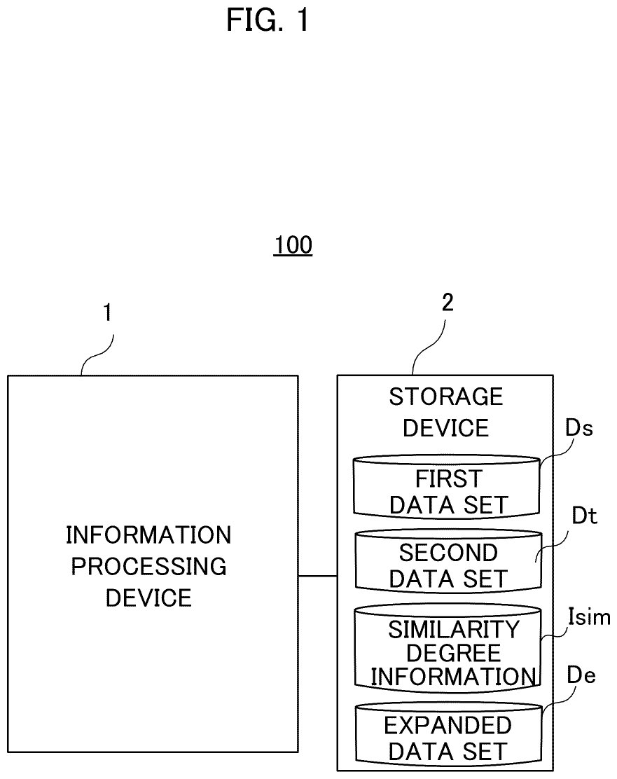

FIG. 1 illustrates a schematic configuration of a data combination system 100 in a first example embodiment. The data combination system 100 combines a plurality of data sets. The data combination system 100 includes an information processing device 1 and a storage device 2.

The information processing device 1 generates an expanded data set “De” into which data of a first data set “Ds” and data of a second data set “Dt” related to the data of the first data set Ds are integrated, wherein the first data set Ds and the second data set Dt are stored in the storage device 2. The information processing device 1 may be configured by a plurality of devices. In this case, the plurality of devices may execute the allocated process using cloud computing technology or the like, and exchange information necessary for the allocated processing with one another.

The storage device 2 is one or more memories for storing various information necessary for processing to be performed by the information processing device 1. The storage device 2 may be an external storage device, such as a hard disk, connected to or embedded in the information processing device 1, or may be a storage medium, such as a flash memory. The storage device 2 may be one or a plurality of server devices that perform data communication with the information processing device 1. The storage device 2 stores the first data set Ds, the second data set Dt, similarity degree information Isim, and the expanded data set De. When the storage device 2 is configured by a plurality of devices, the information may be stored in a distributed manner.

The first data set Ds and the second data set Dt each is a set of data which includes one or more elements. Examples of the first data set Ds and the second data set Dt include a database of action history (e.g., purchasing history, and web search history) for respective users, questionnaire results for respective users, comment (sentence) information and image data that are open to the public in the SNS (Social Networking Service) for respective users. The first data set Ds and the second data set Dt may be data sets generated by different entities (companies, individuals, municipalities, etc.,), or may be data sets generated by different departments (e.g., a sales department and a marketing department) in a single entity, respectively. Besides, these datasets may not be sets of data associated with users. Examples of the data constituting the data set include sentences included in websites, detailed information (regarding raw materials, catch phrases) attached to goods by a company, or unique tags (e.g., goods attributes tagged according to the preferences and values of consumers) attached to websites or goods by a company, or the like.

The similarity degree information Isim is information relating to the degree of similarity between data in the first data set Ds and data in the second data set Dt. The similarity degree information Isim is, for example, information relating to parameters for configuring a function (engine) which outputs, when the data of the first data set Ds and the data of the second data set Dt are inputted thereto, the degree of similarity of these inputted data. The similarity degree information Isim may be information representing the degree of similarity for all combinations between the data of the first data set Ds and the data of the second data set Dt. In this case, the degree of similarity are calculated in advance by preprocessing or the like, and are stored in the storage device 2 as the similarity degree information Isim.

The expanded data set De is a data set that is expanded first data set Ds expanded based on the second data set Dt, and is generated by combining data elements of the second data set Dt related to data of the first data set Ds with the data of the first data set Ds. The details of the method of generating the expanded data set De will be described below.

### (2) Hardware Configuration

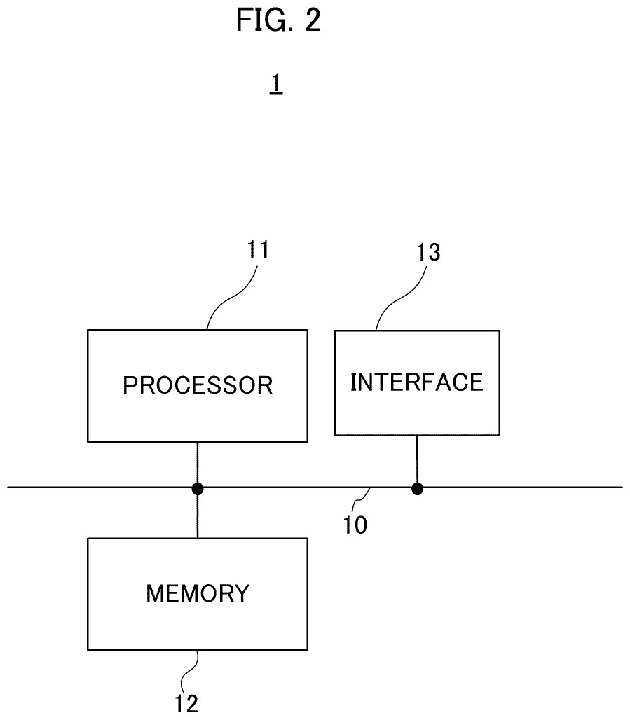

FIG. 2 shows an example of a hardware configuration of the information processing device 1. The information processing device 1 includes a processor 11, a memory 12, and an interface 13 as hardware. The processor 11, the memory 12 and the interface 13 are connected to one another via a data bus 10.

The processor 11 executes a predetermined process by executing a program or the like stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories used as working memories and non-volatile memories for storing the information necessary for the information processing device 1 to process data, such as a RAM (Random Access Memory) and a ROM (Read Only Memory). The memory 12 may include an external storage device, such as a hard disk, that is connected or embedded in the information processing device 1, or may include a storage medium, such as a removable flash memory. In the memory 12, a program for the information processing device 1 to execute each process in the present example embodiment is stored. The memory 12 may function as a storage device 2 or a part of the storage device 2 to store at least one of the first data set Ds, the second data set Dt, the similarity degree information Isim, and the expanded data set De.

The interface 13 is one or more interfaces for electrically connecting the information processing device 1 to other devices. Examples of these interfaces include a wireless interface, such as network adapters, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may further include an input unit for receiving a user input, an output unit such as a display and a speaker, or the like.

### (3) Data Combination Process

A data combination process performed by the information processing device 1 is described. In summary, the information processing device 1 specifies, based on the similarity degree information Isim, data of the second data set Dt related to data of the first data set Ds, and determine one or more elements of the specified data of the second data set Dt to be combined with the data of the first data set Ds. Accordingly, the information processing device 1 suitably executes the combination of the data related to both of the first data set Ds and the second data set Dt.

### (3-1) Functional Block

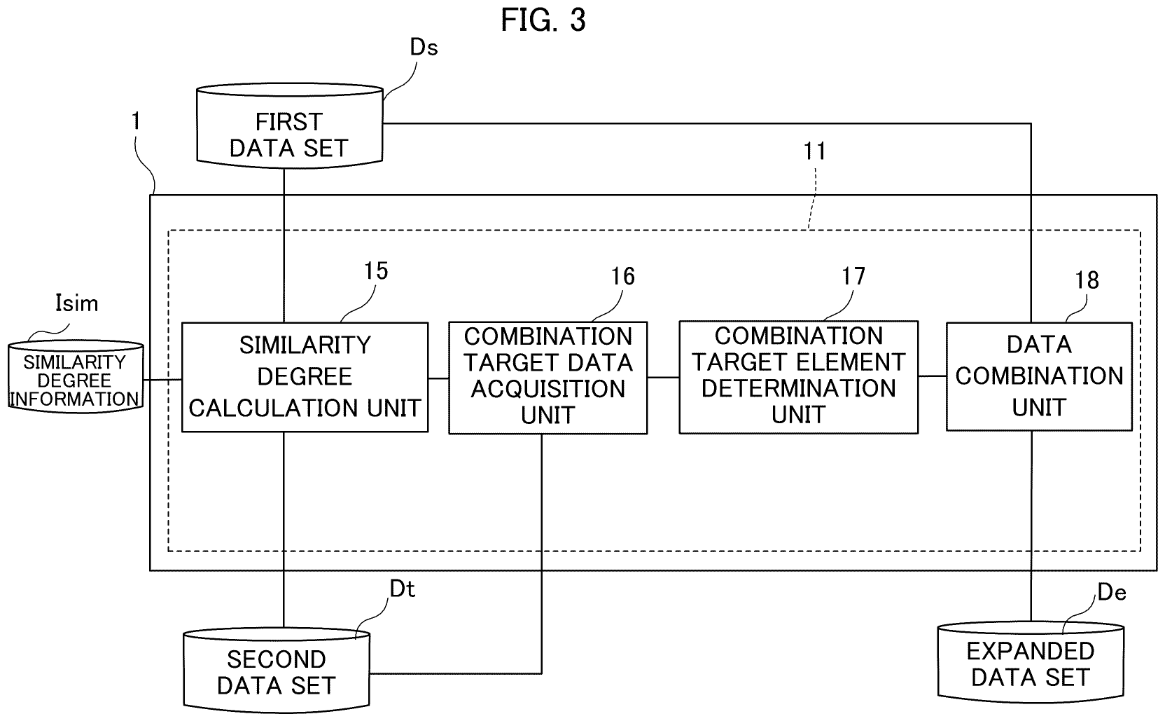

FIG. 3 is an example of a functional block diagram of the information processing device 1 related to the data combination process according to the first example embodiment. As shown in FIG. 3, the processor 11 of the information processing device 1 functionally includes a similarity degree Calculation unit 15, a combination target data acquisition unit 16, a combination target element determination unit 17, and a data combination unit 18. In FIG. 3, blocks for transmitting and receiving data to or from each other are connected by a solid line, but the combination of blocks for transmitting and receiving data is not limited to the combination shown in FIG. 3. The same applies to the drawings of other functional blocks described below.

The similarity degree Calculation unit 15 calculates the degree of similarity for all possible combination between the data of the first data set Ds and the data of the second data set Dt, on the basis of the similarity degree information Isim. In this case, when the similarity degree information Isim is information regarding a function which calculates the degree of similarity, the similarity degree Calculation unit 15 inputs data of the first data set Ds and data of the second data set Dt to the function built based on the similarity degree information Isim and thereby calculates the degree of similarity between the pair of the inputted data. The similarity calculation unit 15 supplies the calculated degree of similarity to the combination target data acquisition unit 16. The similarity degree information Isim may be information indicating the degree of similarity for all possible combination between the data of the first data set Ds and the data of the second data set Dt. In this instance, the similarity calculation unit 15 acquires the degree of similarity indicated by the similarity degree information Isim as the degree of similarity to be outputted to the combination target data acquisition unit 16.

The combination target data acquisition unit 16 acquires, as target data (also referred to as “combination target data”) to be incorporated into data of the first data set Dt, data of the second data set Ds related to the data the first data set Dt, based on the degree of similarity calculated by the similarity calculation unit 15. It is noted that there may be two or more combination target data for one data of the first data set Ds, or that there may be data of the first data set Ds having no corresponding combination target data. The combination target data acquisition unit 16 supplies the combination target data acquired for each data of the first data set Ds to the combination target element determination unit 17.

The combination target element determination unit 17 determines one or more elements (also referred to as “combination target elements”) to be incorporated into data of the first data set Ds, wherein the combination target elements come from the elements of the combination target data acquired by the combination target data acquisition unit 16. As will be described later, the combination target element may be an element selected (extracted) from the elements of the combination target data, or may be an element generated by statistical processing of elements of plural combination target data which fall under the same type.

The data combination unit 18 performs a process of combining the combination target elements determined by the combination target element determination unit 17 with the data of the first data set Ds. Specifically, the data combination unit 18 generates data (expanded data) obtained by adding the combination target elements determined by the combination target element determination unit 17 to the data of the target first data set Ds as additional elements. The data combination unit 18 generates expanded data set De that is the first data set Ds updated by the expanded data.

Here, each component of the similarity calculation unit 15, the combination target data acquisition unit 16, the combination target element determination unit 17, and the data combination unit 18 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using user programmable integrated circuit such as FPGA (Field-Programmable Gate Array) and microcontrollers. In this case, an integrated circuit may be used to realize a program to function as each of the above components. Further, at least a part of the components may be constituted by an ASSP (Application Specific Standard Produce), an ASIC (Application Specific Integrated Circuit) or a quantum processor (quantum computer control chip). Thus, each of the above-described components may be realized by various hardware. The above explanation is true in other example embodiments described later. Furthermore, each of these components may be implemented by the cooperation of a plurality of computers, for example, using cloud computing technology.

### (3-2) Processing in Similarity Degree Calculation Unit

A specific calculation method of the degree of similarity by the similarity degree calculation unit 15 will be described. Hereinafter, “D^{s}” denotes the space (i.e., the raw data) of the first data set Ds, and “d^{s}ᵢ” denotes the data related to user i (i∈U^{s}, U^{s} is a set of users registered in the first data set Ds). “D^{t}” denotes the space of the second data set Dt, and “d^{t}ⱼ” denotes the data related to user j (j∈U^{t}, U^{t} is a set of users registered in the second data set Dt). The first data set Ds and the second data set Dt each may not be a set of data related to users. In this instance, the above-mentioned i (i∈U^{s}) and j (j∈U^{t}) represent the indices (identifiers) of the data in the corresponding data set, respectively.

First, a function “sim” represented by the similarity degree information Isim will be described. The function sim may be any function for calculating the degree of similarity of the two data. The function sim is defined as shown below.

$$sim : ( {d}_{i}^{s} , {d}_{j}^{t} ) ∈ {D}^{s} \times {D}^{t} ↦ s i m ( {d}_{i}^{s} , {d}_{j}^{t} ) ∈ R \qquad [ Formula 1 ]$$

Here, the data d^{s}ᵢ and d^{t}ⱼ each may be a record (i.e., a user action item) of the activity history such as purchasing goods, browsing a website, listening to a music, or may be a sentence (comment) or an image equivalent to a post on a SNS. If the data set is posts on a SNS, the data d^{s}ᵢ and d^{t}ⱼ may be tags with the posts. The data d^{s}ᵢ and d^{t}ⱼ may also be numerical data regarding a multiple-choice questionnaire result for respective users. The types of d^{s}ᵢ and d^{t}ⱼ may be different from each other.

Next, a description will be given of the details of process to be executed by the similarity calculation unit 15 using the function sim for each format of the target data.

When both data d^{s}ᵢ and d^{t}ⱼ are sentence data, for example, the similarity calculation unit 15 vectorizes the data by applying BoW (Bag of Words), TF-IDF, Okapi BM25, or another deep learning method (such as Doc2Vec). Then, the similarity calculation unit 15 calculates the cosine similarity of the obtained numerical vectors as the degree of similarity of the data. In another example, the similarity calculation unit 15 may calculate the Jaccard similarity coefficient or the Dice coefficient calculated for the texts included in the data d^{s}ᵢ and d^{t}ⱼ as the degree of similarity of the data.

When both of the data d^{s}ᵢ and d^{t}ⱼ are image data, for example, the similarity calculation unit 15 calculates the cosine similarity of the feature vectors obtained by inputting the above-described image data to a trained feature extractor trained by deep learning or the like as the degree of similarity of the data. In another example, the similarity degree calculation unit 15 extracts features based on SIFT for the respective image data and calculates a value obtained by inverting the sign of EMD (Earth Mover's Distance) of the features as the degree of similarity of the data.

When both the data d^{s}ᵢ and d^{t}ⱼ are data related to attributes of users, such as a demographic attribute, for example, the similarity calculation unit 15 determines the degree of similarity of the data so that the similarity of the data increases as the degree of commonality of the attributes increases. For example, when information representing age, gender, residential area, or/or family composition is included as elements of the data d^{s}ᵢ and d^{t}ⱼ, the similarity calculation unit 15 calculates the degree of similarity according to the number of elements in common. In this case, when the degree of contribution (weight) for each element to the degree of similarity is provided, the similarity calculation unit 15 may calculate the degree of similarity in consideration of the degree of contribution.

Next, a description will be given of a specific example of calculation of the degree of similarity when the data d^{s}ᵢ and d^{t}ⱼ are data in different formats. The similarity calculation unit 15 first calculates features (feature values) of the data d^{s}ᵢ in the feature space specific to the first data set and features of the data d^{t}ⱼ in the feature space specific to the second data set, respectively. The similarity calculation unit 15 converts the features of the data d^{s}ᵢ in the feature space specific to the first data set and the features of the data d^{t}ⱼ in the feature space specific to the second data set to features in a universal feature space for (common feature space in) the first data set and the s second data set, respectively. The similarity calculation unit 15 calculates the degree of similarity between the data d^{s}ᵢ and d^{t}ⱼ based on the cosine similarity of the features of the data d^{s}ᵢ and d^{t}ⱼ converted into the universal feature space.

Based on the above-exemplified methods and the like, the similarity degree calculation unit 15 calculates the degree of similarity for all combination of data between the first data set Ds and the second data set Dt. In this instance, the degree of similarity for all combination of data between the first data set Ds and the second data set Dt is represented by the following “S”.

$$S = {( sim ( {d}_{i}^{s} , {d}_{j}^{t} ) )}_{{d}_{i}^{s} ∈ {D}^{s} , {d}_{j}^{t} ∈ {D}^{t}} \qquad [ Formula 2 ]$$

### (3-3) Processing in Combination Target Data Acquisition Unit

Next, a description will be given of a method of acquiring the combination target data by the combination target data acquisition unit 16. The combination target data acquisition unit 16 performs a process of realizing the following mapping “Sync”.

$$Sync : {d}_{i}^{s} ∈ {D}^{s} ↦ \{ {d}_{{j}_{1}}^{t} , … {d}_{{j}_{k}}^{t} \} ⊂ {D}^{t} \qquad [ Formula 3 ]$$

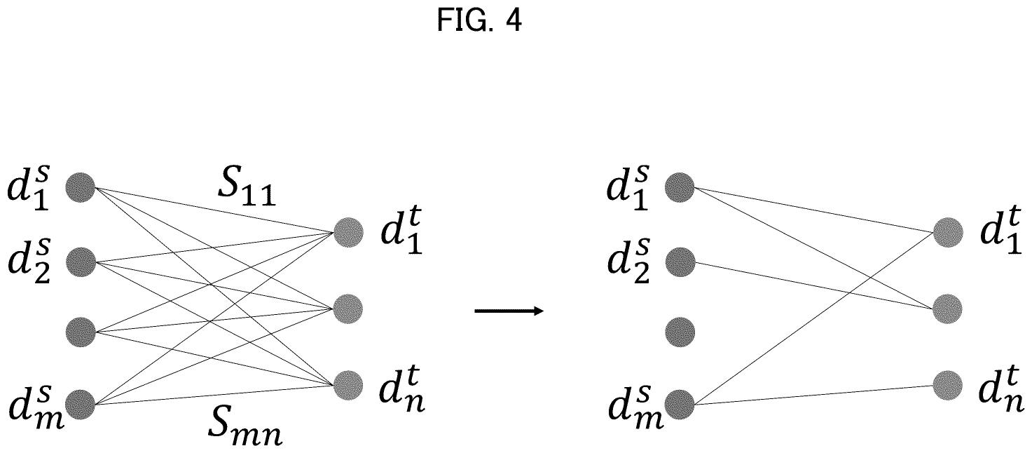

FIG. 4 is a diagram showing an outline of the mapping Sync. In FIG. 4, first, the degree of similarity “Sᵢⱼ” (=sim (d^{s}ᵢ, d^{t}ⱼ)) is calculated for all combination between each data {d^{s}₁, d^{s}₂, . . . , d^{s}ₘ} of the first data set Ds and each data {d^{t}₁, . . . , d^{t}ₙ} of the second data set Dt. The combination target data acquisition unit 16 specifies the data {d^{t}ⱼ₁, . . . , d^{t}ⱼₖ} of the second data set Dt related to d^{t}ᵢ of the first data set Ds as the combination target data based on the degree of similarity Sᵢⱼ for all combination between the data {d^{s}₁, d^{s}₂, . . . , d^{s}ₘ} of the first data set Ds and the data {d^{t}₁, . . . , d^{t}ₙ} of the second data set Dt. In the right-hand diagram in FIG. 4, the data of the first data set Ds and the corresponding combination target data are connected by line.

Here, the correspondence between the data of the first data set Ds and the combination target data of the second data set Dt is not limited to one-to-one correspondence, and may be a plural-to-one correspondence, or a one-to-plural correspondence. In addition, there may be data in the first data set Ds having no corresponding combination target data.

Next, a specific example of the method of specifying the combination target data will be described. For example, the combination target data acquisition unit 16 specifies the data of the second data set Dt having the largest degree of similarity to the first data set Ds as the combination target data to the data d^{s}ᵢ (∈D^{s}). In this instance, single data of the second data set Dt is identified as the combination target data for each data of the first data set Ds. In another example, the combination target data acquisition unit 16 specifies the data of the second data set Dt whose degree of similarity is equal to or greater than a predetermined threshold value as the combination target data for the first data set Ds data d^{s}ᵢ (∈D^{s}). In this example, there may be data of the first data set Ds having no specified combination target data, or there may be data of the first data set Ds having a plurality of specified combination target data. In yet another example, the combination target data acquisition unit 16 specifies the data of the second data set Dt having top degrees of similarity for each data of the first data set Ds as the combination target data. In yet another example, the combination target data acquisition unit 16 specifies the data of the second data set Dt related to the data of the first data set Ds as the combination target data based on a matching algorithm for the two-part graph such as Gale-Shapley algorithm.

The combination target data acquisition unit 16 may specify the combination target data from the above-described degree of similarity based on a probabilistic method. In this case, if “μ_{μ}” denotes the distribution of the data of the second data set Dt to be specified as the combination target data, the mapping Sync is expressed by the following equation.

$$Sync ( {d}_{i}^{s} ) = \{ {d}_{j}^{t} \vert j is sampled from {μ}_{u} \} \qquad [ Formula 4 ]$$

Here, the distribution μ_{μ} may be a uniform distribution, or may be a distribution depending ono the degree of similarity. For example, when using soft-max, the distribution μ_{μ} depending on the degree of similarity is expressed by the following equation.

$${μ}_{u} ( j is sampled ) = exp ( {S}_{ij} ) / {\sum }_{j ∈ {U}^{t}} exp ( {S}_{ij} ) \qquad [ Formula 5 ]$$

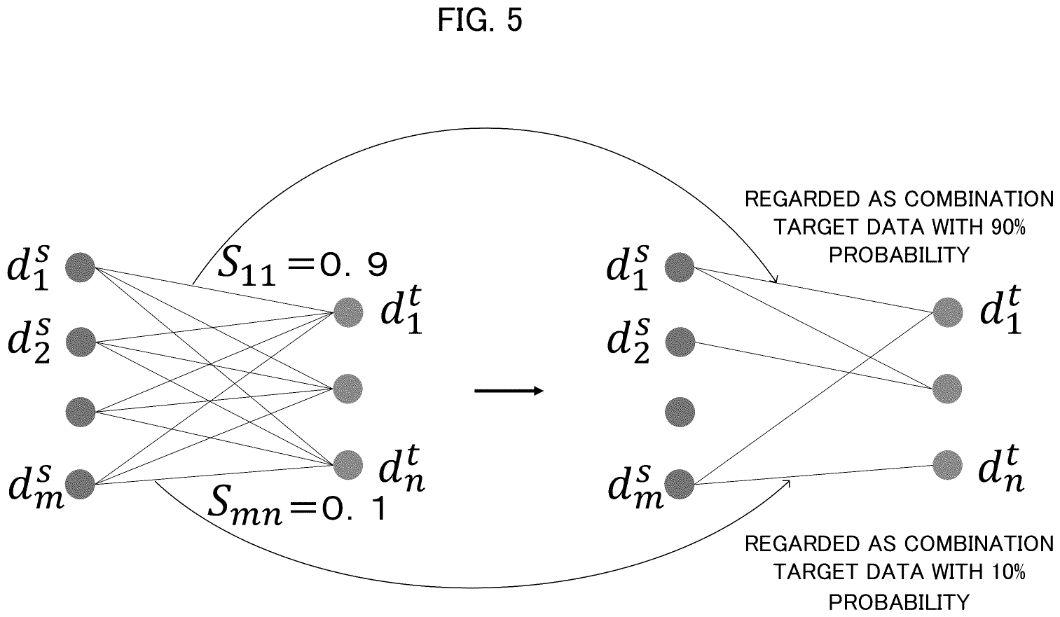

FIG. 5 is a diagram showing an outline of a method for specifying the combination target data based on a probabilistic method. In this case, for example, when the degree of similarity between the data d^{s}₁ of the first data set Ds and the data d^{t}₁ of the second data set Dt is “0.9,” the combination target data acquisition unit 16 specifies the data d^{t}₁ as the combination target data for the data d^{s}₁ with a probability of 90%. On the other hand, when the degree of similarity between the data d^{s}ₘ of the first data set Ds and the data d^{t}ₙ of the second data set Dt is “0.1”, the combination target data acquisition unit 16 specifies the data d^{t}ₙ as the combination target data for the data d^{s}ₘ with a probability of 10%. As described above, the combination target data acquisition unit 16 may specify the data of the second data set Dt as the combination target data according to the probability according to the degree of similarity between the data of the first data set Ds and the data of the second data set Dt.

According to the above examples, the combination target data acquisition unit 16 can suitably acquire the combination target data based on the degree of similarity calculated by the similarity calculation unit 15.

### (3-4) Processing in Combination Target Element Determination Unit

Next, a method of determining the combination target element by the combination target element determination unit 17 will be described. Hereinafter, “Sync (d^{s}ᵢ)={d^{t}ⱼ₁, . . . , d^{t}ⱼₖ}⊂D^{t})” denotes combination target data for data d^{s}ᵢ (∈D^{s}) of the first data set Ds.

In this case, the following map “φ” that specifies the combination target element is prepared.

$$ϕ : Sync ( {d}_{i}^{S} ) ↦ ϕ ( Sync ( {d}_{i}^{s} ) ) ∈ {D}^{t} \qquad [ Formula 6 ]$$

In this case, the combination target element determination unit 17 considers φ (Sync (d^{s}ᵢ)) as the combining target element and outputs “d^{s}ᵢ∪φ (Sync (d^{s}ᵢ))” as expanded data (i.e., the updated data of the data d^{s}ᵢ in the expanded data set De).

Next, specific embodiments (first embodiment to third embodiment) of the mapping φ will be described.

In the first embodiment, the combination target element determination unit 17 extracts, as a combination target element, the element such that a function value with respect to an element of the combination target data is equal to or larger than a predetermined threshold value “θ”. In this case, assuming that “d^{union}” denotes the set of elements of the combination target data for each data of the first data set Ds subject to combination, the mapping φ is expressed by the following equation (1) using the element aₗ∈d^{union}.

$$\begin{matrix}[ Formula 7 ] & \\ ϕ ( S y n c ( {d}_{i}^{s} ) ) := \{ {a}_{ℓ} \vert func ( {a}_{ℓ} ) \geq θ , {a}_{ℓ} ∈ {d}^{union} \} & ( 1 )\end{matrix}$$

In this case, for example, the function func (a) is a function for calculating the number of times (i.e., the number of appearance) the element a appears in the set d^{union}. In this case, when the threshold value θ is “3”, the combination target element determination unit 17 specifies, based on the equation (1), an element whose number of appearances is three or more times as a combination target element. In another example, the function func (a) may be a function for calculating a value (i.e., the frequency of appearance) obtained by dividing the number of appearances of the element “a” by the number of elements of the set d^{union}. In this case, when the threshold value θ is 0.3, the combination target element determination unit 17 specifies, based on the equation (1), an element whose frequency of appearances is equal to or larger than 30% as a combination target element. In yet another instance, the functional func (a) may be a value determined by TF-IDF or Okapi BM25 or the like. The above-described frequency of appearance and the value determined by TF-IDF or Okapi BM25 are examples of the “index value regarding the frequency of appearances”, respectively.

In these examples in the first embodiment, the combination target element determination unit 17 may correct the functional func (a) in accordance with the degree of similarity used for specifying the combination target data to which the element “a” belongs. In this case, for example, if the value obtained by multiplying the value of the function func (a) by the above-described degree of similarity is equal to or greater than the threshold value θ, the combination target element determination unit 17 determines that the element “a” is a combination target element. Thus, in some embodiments, the combination target element determination unit 17 corrects the function func (a) such that the corrected function func (a) positively correlates the above-described degree of similarity. In this case, on the assumption that the same value of the function func (a) is obtained, the combination target element determination unit 17 increases the corrected value of the function func (a) of an element of the combination target data with increase in the degree of similarity of the element of the combination target data. Accordingly, the combination target element determination unit 17 can suitably calculate the functional func (a) so that the higher the degree of similarity of an element of the combination target data is, the easier the element is selected as the combination target element.

In another example of the first embodiment, when the element “a” is a word, the function func (a) may be a function which returns a value equal to or greater than the threshold value θ if the element “a” is such a word that satisfies a predetermined condition, and which returns a value less than the threshold value θ when the element “a” is such a word that does not satisfy the predetermined condition.

In this case, in some embodiments, the function func (a) is a function configured to output a value based on the classification result of the element of the combination target data. In this case, for example, the function func (a) may be a function that returns a value equal to or greater than the threshold value θ if the element “a” belongs to a class (genre) that has the largest number (or one of the upper numbers) of elements in the set d^{union} and that returns a value less than the threshold value θ if the element “a” does not belong to the class. In this case, for example, in the classification process in the function func (a), the combination target element determination unit 17 may determine the class (genre) for each word based on the corresponding information between each possible word and the corresponding class (genre) stored in advance in the memory 12 or the like. In another example, in the classification process in the function func (a), the combination target element determination unit 17 numerically vectorizes each word by Word2Vec or the like, and identifies, as independent class (genre), each cluster generated by performing arbitrary s clustering for numerical vectors.

In another example, the predetermined condition described above is a condition relating to a proper noun, and the function func(a) may be a function which returns a value equal to or greater than the threshold value θ if the element “a” is a proper noun and which returns a value less than the threshold value θ otherwise. In yet another example, the predetermined condition described above is a condition relating to the number of characters, and the function func (a) may be, for example, a function which returns a value equal to or greater than the threshold value θ if the element “a” is within the range of a predetermined number of characters and which returns a value less than the threshold value θ otherwise. In this way, the function func (a) may output as a function value a value based on any classification result of the element “a”.

Next, a description will be given of a second embodiment of the map φ. In the second embodiment, the combination target element determination unit 17 specifies, as the combination target element, an element which is probabilistically extracted according to a certain distribution “μₐ” from the elements belonging to the set d^{union}. In this case, the map φ is expressed by the following equation.

$$ϕ ( S y n c ( {d}_{i}^{s} ) ) = \{ {a}_{ℓ} \vert {a}_{ℓ} is sampled from {μ}_{a} , {a}_{ℓ} ∈ {d}^{union} \} \qquad [ Formula 8 ]$$

Here, the distribution μₐ is a distribution based on the function value outputted by any function func (a) described in the first embodiment. For example, when “s” denotes a soft-max function, the distribution μₐ is expressed by the following equation (2).

$$\begin{matrix}[ Formula 9 ] & \\ \begin{matrix}{μ}_{a} ( {a}_{ℓ} is sampled ) = s ( func ( {a}_{ℓ} ) ) \\ = exp ( func ( {a}_{ℓ} ) ) / {\sum }_{a ∈ {d}^{union}} exp ( func ( a ) ) )\end{matrix} & ( 2 )\end{matrix}$$

Thus, according to the second embodiment, the combination target element determination unit 17 can probabilistically select the combination target element from the elements belonging to the set d^{union}.

Next, a description will be given of a third embodiment of the map φ. In this case, there are a plurality of combining target data corresponding to one data of the first data set Ds, and the combination target data includes numerical data, such as annual earnings and height, as its elements. In this case, in the third embodiment, the combination target element determination unit 17 calculates the combination target element that is numerical data obtained by applying the function func to the elements, which are numerical data, for each type (e.g., for each annual earnings group, for each height group) of the elements.

The function func in this case is, for example, a function for calculating a statistic, such as average, largest value, smallest value, median value, and variance, by using, as arguments, elements which belong to the each type among a plurality of combination target data. In some embodiments, the function func may be a function for calculating a weighted mean based on the degree of similarity Sᵢⱼ used for specifying the combination target data to which the respective elements belong. In this case, the combination target element determination unit 17 calculates the combination target element based on the following equation.

$$ϕ ( Sy n c ( {d}_{i}^{s} ) ) = ϕ ( Sy n c ( {d}_{i}^{s} ) ; S ) = {\sum }_{{d}_{j}^{t} ∈ Sync ( {d}_{i}^{s} )} {S}_{ij} {d}_{j}^{t} / {\sum }_{{d}_{j}^{t} ∈ Sync ( {d}_{i}^{s} )} {S}_{ij} \qquad [ Formula 10 ]$$

In this way, the combination target element determination unit 17 calculates the combination target element by statistically processing the elements that are the numerical data, on the basis of the weighting based on the degree of similarity. Thus, the combination target element determination unit 17 can suitably determine the combination target element so as to increase the weight for an element of the combination target data with increasing degree of similarity between the element and the data of the first data set Ds subject to combination.

As described above, according to the third embodiment, the combination target element determination unit 17 can suitably determine the combination target element to be a statistic, such as the representative value, for each type-specific group of numerical data present among a plurality of combination target data.

Here, a supplementary description will be given of the handling of elements of the combination target data other than the numerical data in the third embodiment. For each data of the first data set Ds subject to combination, the combination target element determination unit 17 may specify all (i.e., a union set) of the elements of the combination target data other than the numerical data as combination target elements, or may use only element(s) (i.e., a product set of elements) that are common in all the combination target data as the combination target element(s). In another example, for each data of the first data set Ds subject to combination, the combination target element determination unit 17 may specify element(s) randomly selected from the elements of the combination target data other than the numerical data as combination target element(s). In yet another example, the combination target element determination unit 17 may select the combination target element(s) based on the first embodiment or the second embodiment for the elements of the combination target data other than the numerical data.

In this way, according to the first embodiment to the third embodiment of the map (p, the combination target element determination unit 17 can suitably suppress noisy combination of the elements irrelevant to the original data subject to combination. Further, the combination target element determination unit 17 can suitably select the combination target data when a plurality of data are to be combined with one original data. In this case, the combination target element determination unit 17 can flexibly select data (elements) to be combined in consideration of the degree of similarity ( degree of association) between data in a suitable manner.

### (4) Specific Examples

Next, specific examples of the above-described data combination process will be described with reference to the drawings.

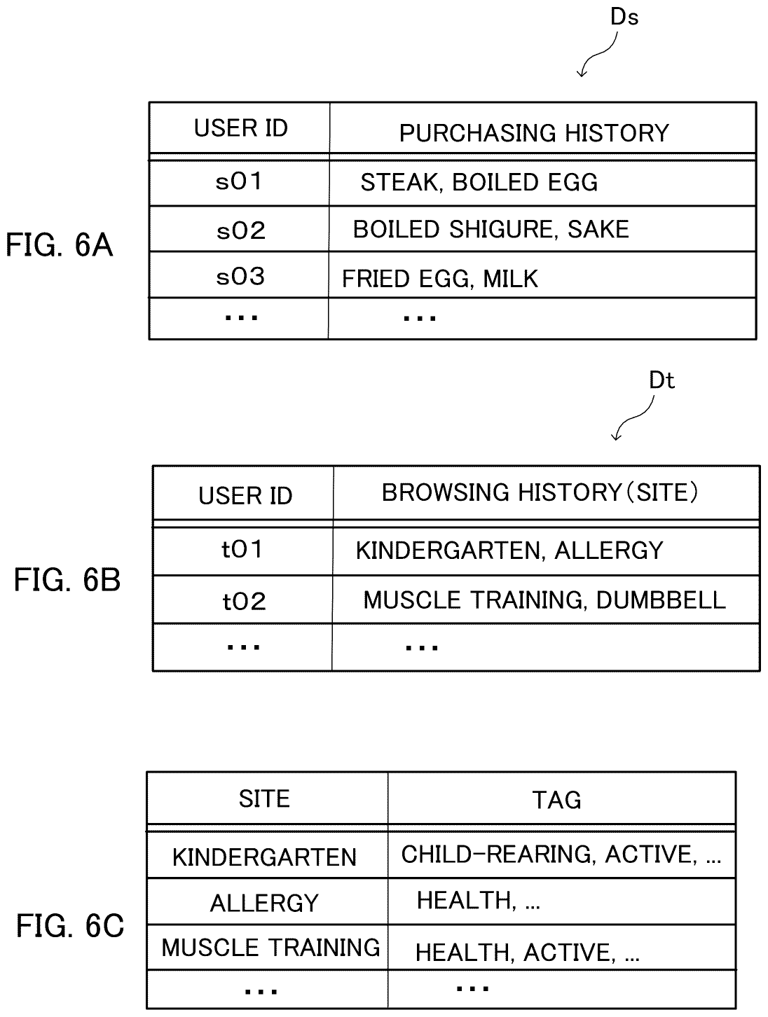

FIG. 6A is an example of the data structure of the first data set Ds representing the purchasing history in a certain supermarket, and FIG. 6B is an example of the data structure of the second data set Dt representing the browsing history in the internet. FIG. 6C is an example of table information representing tags associated with each site (including website and advertisement).

Hereinafter, “d^{s}ᵢ=(a^{s}₁, . . . , a^{s}ₘ)∈D^{s}” refers to the purchasing history data of user i, and “a^{s}₁” refers to goods sold in a supermarket. In addition, “d^{t}ᵢ=(a^{t}₁, . . . , a^{t}ₘ)∈D^{t}” refers to the browsing history data of user j, and “a^{t}₁” refers to a site that can be browsed on the internet. As shown in FIG. 6C, each site is associated with tags.

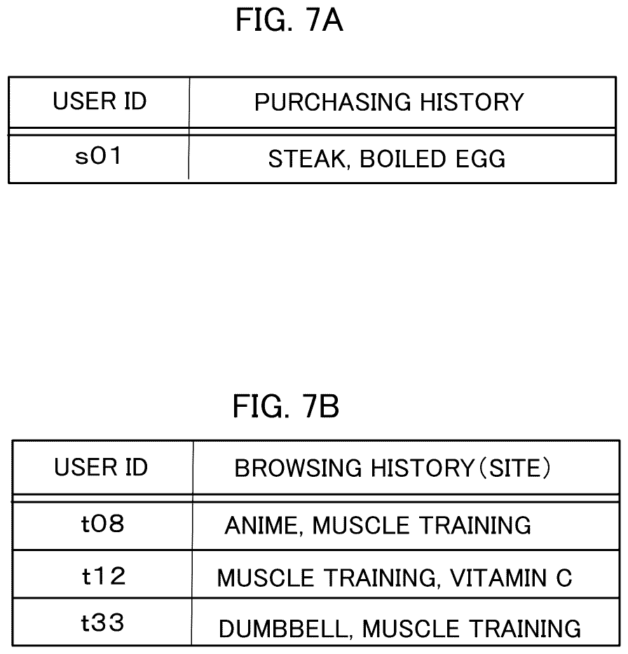

FIGS. 7A and 7B show the combination of data to be combined. FIG. 7A shows the purchasing history data of the user ID “s01”, and FIG. 7B shows the browsing history data of the user ID “t08”, “t12”, and “t33”. Here, the combination target data acquisition unit 16 acquires data of the second data set Dt corresponding to the user ID “t08” “t12”, and “t33” as the combination target data for the data of the first data set Ds illustrated in FIG. 7A, based on the degree of similarity calculated by the similarity calculation unit 15.

Then, the combination target element determination unit 17 determines the combination target element, as an example, according to the second embodiment of the mapping φ shown in the equation (2), using the soft-max function s and the function func configured to output the number of appearances of the argument in the set d^{union}.

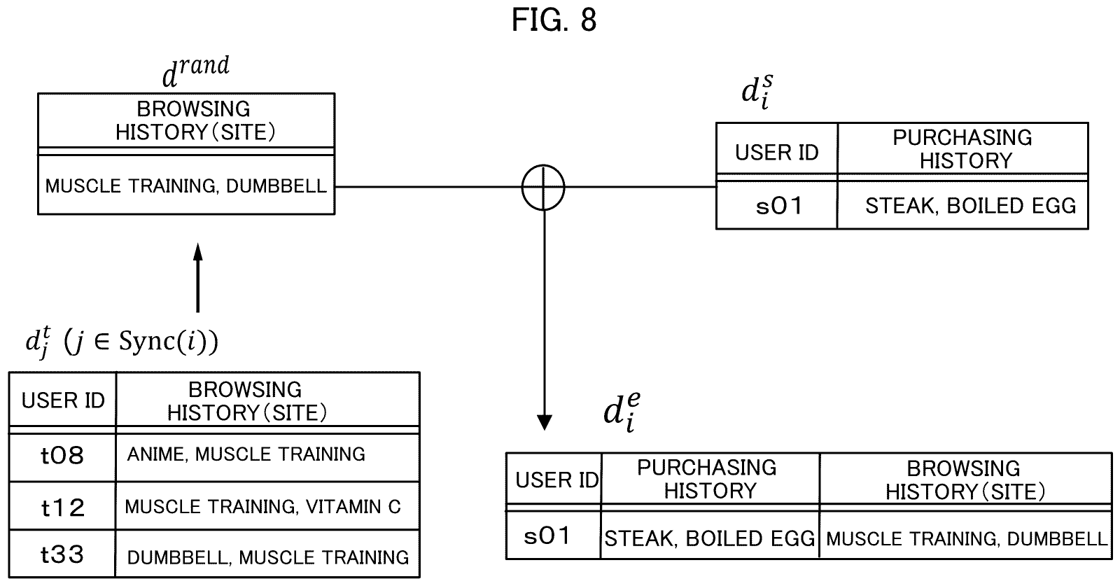

FIG. 8 illustrates an overview of generating expanded data “d^{e}ᵢ” by combining the data d^{s}ᵢ (∈D^{s}) shown in FIG. 7A with the data d^{t}ⱼ (j∈Sync (i)) shown in FIG. 7B. In this case, “d^{rand}” denotes data configured by combination target elements that are determined by the combination target element determination unit 17.

In this case, on the basis of the formula (2), the combination target element determination unit 17 applies the function func configured to output the number of appearances to each element (anime, muscle training, vitamin C, dumbbell) of the data d^{t}ⱼ of the second data set Dt corresponding to the user ID “t08”, “t12”, and “t33”, respectively. Then, the combination target element determination unit 17 determines the extraction probability of an element of the data d^{t}ⱼ to be a value obtained by rounding the result of applying the function func to the element to 0 to 1 by the soft-max function s and extracts the element probabilistically. In the example shown in FIG. 8, the combination target element determination unit 17 extracts the element “muscle training” whose number of appearances is three times and the element “dumbbell” whose number of appearances is one time as the combination target elements.

Then, the data combination unit 18 generates the expanded data d^{e}ᵢ obtained by incorporating the data d^{rand} which includes the combination target elements into the data d^{s}ᵢ subject to combination. The expanded data d^{e}ᵢ is the data d^{s}ᵢ to which the data d^{rand} is added.

Thus, in the present specific example, the information processing device 1 can suitably execute the data expansion between the data set of the supermarket and the data set of the browsing history of the interne. The expanded data set De thus generated can be used to comprehensively understand the data, and can also be used for recommendation accuracy improvement and marketing measures.

The combination of data sets subject to data combination is not limited to this specific example. For example, the same type of data set between the company and its competitor may be targeted. Further, the target may be the data set of an advertising distributor and the data set of an advertising provider. The data set subject to data combination may not be a set of data associated with the users.

### (5) Processing Flow

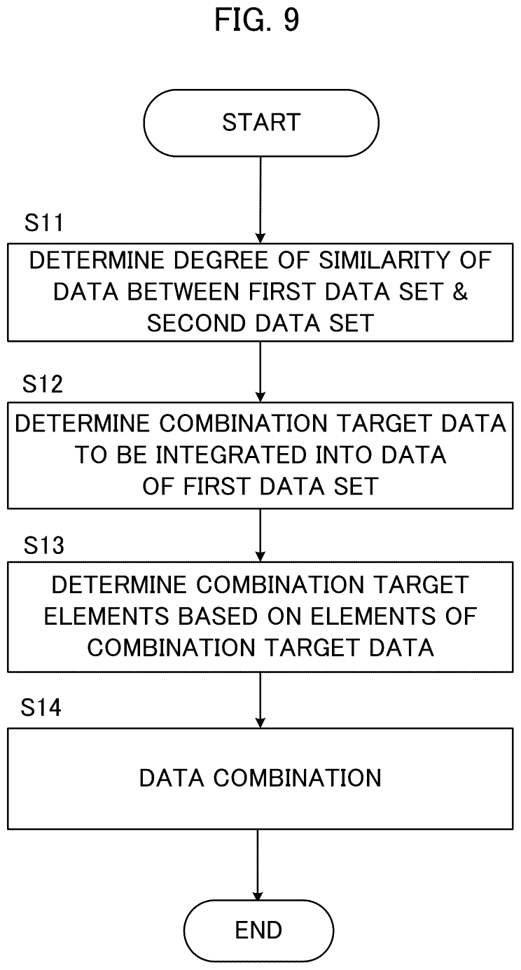

FIG. 9 is an example of a flowchart illustrating a procedure of data combination process that is executed by the information processing device 1.

First, the similarity degree calculation unit 15 of the information processing device 1 determines the degree of similarity between data of the first data set Ds and data of the second data set Dt based on the similarity degree information Isim (step S11). In this instance, the similarity degree calculation unit 15 calculate the degree of similarity for all the combinations between the data of the first data set Ds and the data of the second data set Dt.

Then, the combination target data acquisition unit 16 determines combination target data to be combined with each data of the first data set Ds, on the basis of the degree of similarity calculated at step S11 (step S12).

Then, the combination target element determination unit 17 determines one or more combination target elements to be combined with the each data of the first data set Ds, on the basis of the elements of the combination target data determined at step S12 (step S13). In this instance, the combination object element determination unit 17 determines the combination object elements to be combined with the each data of the first data set Ds based on any one of the first embodiment to the third embodiment mentioned above, for example.

Then, the data combination unit 18 performs data combination (step S14). In this case, the data combination unit 18 generates the expanded data by adding the determined combination target elements to the each data of the first data set Ds, and thereby generates an expanded data set De in which the data of the first data set Ds is updated by the expanded data.

As described above, according to the present example embodiment, the information processing device 1 can suitably acquire the combination target data and generate the expanded data set De.

### (6) Modifications

Instead of acquiring the combination target data on the basis of the similarity degree information Isim, the information processing device 1 may acquire the combination target data on the basis of prior information in which the related data are linked in advance.

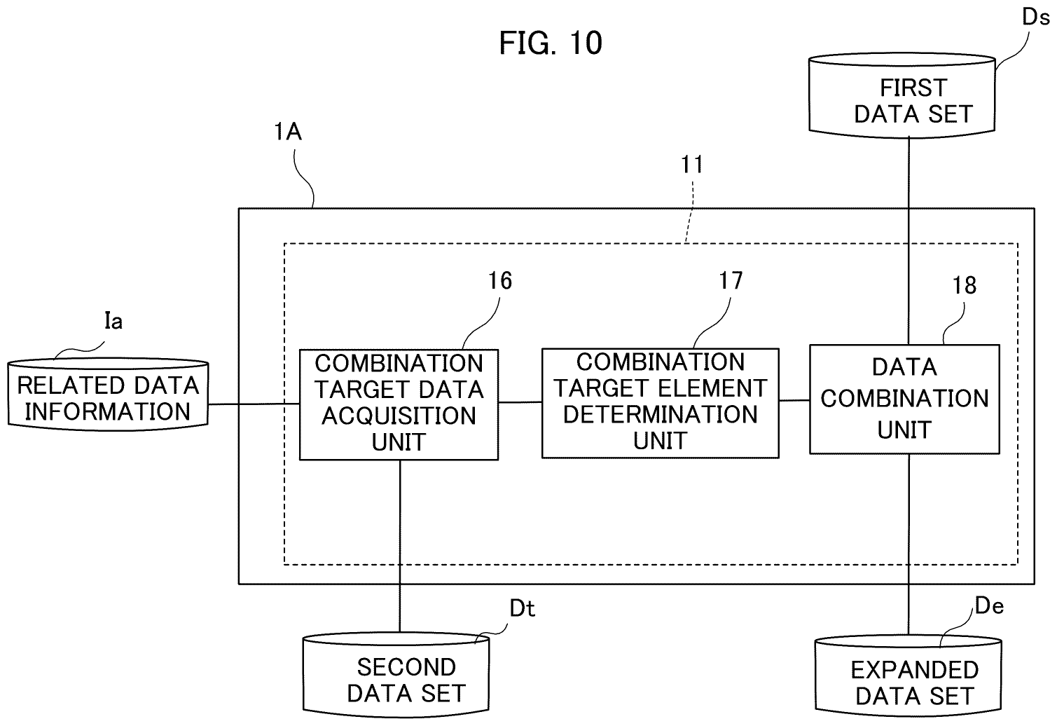

FIG. 10 is an example of functional block diagram of the processor 11 of the information processing device 1A in a modification. The processor 11 of the information processing device 1A functionally includes a combination target data acquisition unit 16, a combination target element determination unit 17, and a data combination unit 18. The storage device 2 stores the related data information Ia instead of the similarity degree information Isim.

Here, the related data information Ia is information representing the correspondence of related data between the first data set Ds and the second data set Dt. The related data information Ia may be, for example, information in which the user ID or any other data identifier (e.g., the record ID) in the first data set Ds is associated with that in the second data set Dt based on the relation between the data. Then, the combination target data acquisition unit 16 acquires the data of the second data set Dt related to each data of the first data set Ds as the combination target data based on the related data information Ia and supplies the acquired combination target data to the combination target element determination unit 17. Thereafter, the combination target element determination unit 17 and the data combination unit 18 perform the processes described in the above-described example embodiment.

As such, the information processing device 1A according to this modification can suitably acquire the combination target data and generate the expanded data set De.

### Second Example Embodiment

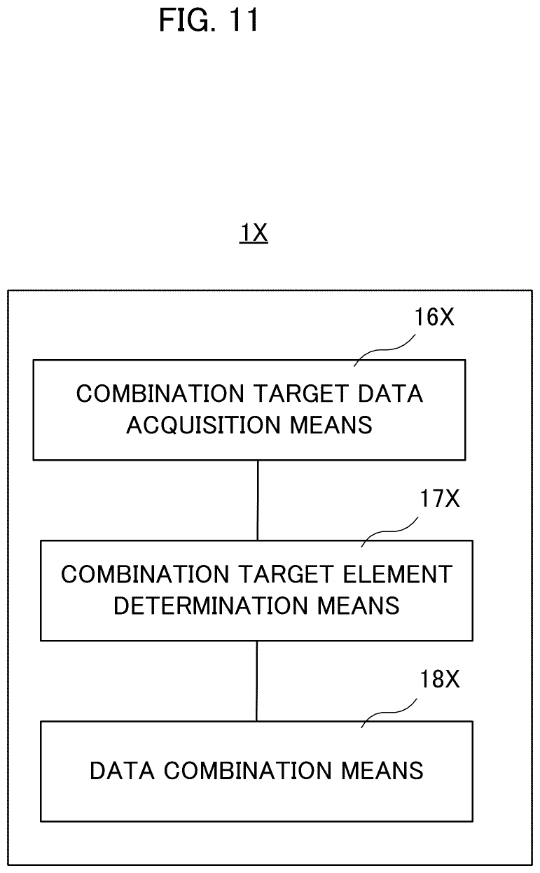

FIG. 11 is a block diagram of an information processing device 1X according to a second example embodiment. As shown in FIG. 11, the information processing device 1X mainly includes a combination target data acquisition means 16X, a combination target element determination means 17X, and a data combination means 18X. The information processing device 1X may be configured by a plurality of devices.

The combination target data acquisition means 16X is configured to acquire combination target data that is data of a second data set to be combined with data of a first data set. Examples of the combination target data acquisition means 16X include the combination target data acquisition unit 16 in the first example embodiment (including a modification, the same applies hereinafter).

The combination target element determination means 17X is configured to determine a combination target element to be combined with the data of the first data set, based on a function value of each element of the combination target data. Examples of the combination target element determination means 17X include the combination target element determination unit 17 in the first example embodiment.

The data combination means 18X is configured to combine the combination target element with the data of the first data set. Examples of the data combination unit 18X include the data combination unit 18 in the first example embodiment.

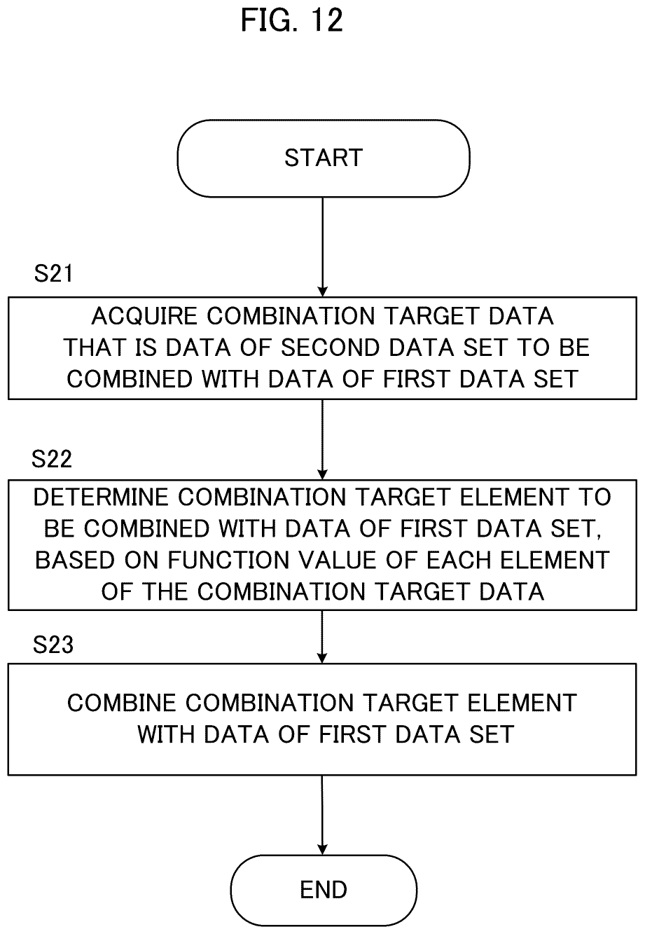

FIG. 12 is an example of a flowchart that is executed by the information processing device 1X in the second example embodiment. First, the combination target data acquisition means 16X acquires combination target data that is data of a second data set to be combined with data of a first data set (step S21). The combination target element determination means 17X determines a combination target element to be combined with the data of the first data set, based on a function value of each element of the combination target data (step S22). The data combination means 18X combines the combination target element with the data of the first data set (step S23).

According to the second example embodiment, an information processing device 1X can suitably combine related data between differing data sets.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1X Information processing device
2 Storage device
11 Processor
12 Memory
13 Interface
100 Data combination system

What is claimed is:

1. An information processing device comprising:
at least one memory configured to store instructions; and
at least one processor configured to execute the instructions to:
acquire combination target data that is data of a second data set to be combined with data of a first data set;
determine a combination target element to be combined with the data of the first data set, based on a function value of each element of the combination target data; and
combine the combination target element with the data of the first data set.

2. The information processing device according to claim 1,
wherein the at least one processor is configured to execute the instructions to determine the combination target element to be an element of the combination target data whose function value is equal to or larger than a predetermined threshold value.

3. The information processing device according to claim 1,
wherein the at least one processor is configured to execute the instructions to probabilistically extract an element of the combination target data as the combination target element, in accordance with a distribution based on the function value.

4. The information processing device according to claim 1,
wherein the at least one processor is configured to execute the instructions to calculates, as the function value, an index value regarding the number of appearances of each element of the combination target data or a frequency of the appearances.

5. The information processing device according to claim 1,
wherein the at least one processor is configured to execute the instructions to calculate the function value that is a value based on a classification result of each element of the combination target data.

6. The information processing device according to claim 1,
wherein the at least one processor is configured to further execute the instructions to calculate a degree of similarity between data of the first data set and data of the second data set, and
wherein the at least one processor is configured to execute the instructions to determine the combination target data based on the degree of similarity.

7. The information processing device according to claim 1,
wherein the at least one processor is configured to execute the instructions to correct the function value based on a degree of similarity between the data of the first data set and the combination target data.

8. The information processing device according to claim 1,
wherein, if the combination target data includes numerical data as elements, the at least one processor is configured to execute the instructions to calculate the combination target element corresponding to the numerical data by weighting based on a degree of similarity between the data of the first data set and the combination target data.

9. A control method executed by a computer, the control method comprising:
acquiring combination target data that is data of a second data set to be combined with data of a first data set;
determining a combination target element to be combined with the data of the first data set, based on a function value of each element of the combination target data; and
combining the combination target element with the data of the first data set.

10. A non-transitory computer readable storage medium storing a program executed by a computer, the program causing the computer to:
acquire combination target data that is data of a second data set to be combined with data of a first data set;
determine a combination target element to be combined with the data of the first data set, based on a function value of each element of the combination target data; and
combine the combination target element with the data of the first data set.
